(19) United States
(12) Patent Application Publication
(10) Pub. No.: US 2022/0215031 A1
(43) Pub. Date: Jul. 7, 2022

(54) IMPROVED DIVERSITY RANKING SELECTION METHODS

(71) Applicant: PAYPAL, INC., San Jose, CA (US)

(72) Inventors: Dorna Bandari, Mountain View, CA (US); Evgeny Igorevich Zamyatin, St. Petersburg (RU)

(21) Appl. No.: 17/611,870

(22) PCT Filed: Jun. 6, 2019
(86) PCT No.: PCT/RU2019/000463

§ 371 Date: Nov. 16, 2021

(51) Int. Cl. G06F 16/2457

(52) U.S. Cl. CPC G06F 16/24578

(57) ABSTRACT

Diversity ranking algorithms can help select a number of items from a larger number of candidate items. Techniques include assessing diversity of items in a set, where each of those items has one or more associated attribute values. Items may also have an associated score, which can vary in different circumstances. Item scores (e.g. relevance scores) can be combined with diversity ranking scores for an evaluation set to produce a weighted diversity ranking score for a candidate item. This weighted score can then be used to determine whether a particular candidate item should be added to a set of existing items (e.g. a set of items already selected). A window size can also be used when performing diversity ranking, and in some cases, an evaluation set for ranking purposes includes only a subset of existing items plus the candidate item.

### TECHNICAL FIELD

This disclosure relates to improvements in digitally-based diversity ranking selection techniques, such as may be used to ensure that individual items in a group of items are not too similar to one another.

### BACKGROUND

Diversity ranking techniques may be used in various technological contexts. As one example, consider an electronic digest of information that is sent to a user. If this information is about scientific journal articles for chemical manufacturing research, for example, there may be hundreds of articles that were published worldwide in the last month. The digest sent to a user, however, may only contain ten of those hundreds of articles. A diversity ranking technique can help to prevent the user from getting information items (e.g. articles) that are similar—the user may not want to see that seven of ten stories, for example, relate to the same topic. Applicant recognizes that diversity ranking techniques can be improved, however.

### BRIEF DESCRIPTION OF THE DRAWINGS

FIG. 1 illustrates a block diagram of a system including user systems, a front end server, backend server, diversity system, and database, according to some embodiments.

FIG. 2A illustrates a diagram relating to the selection of items for transmission to a user system, according to some embodiments.

FIG. 2B illustrates a further diagram relating to the selection of items for transmission to a user system, according to some embodiments.

FIG. 3 illustrates a flowchart of a method relating to diversity ranking of items, according to some embodiments.

FIG. 4 is a diagram of a computer readable medium, according to some embodiments.

FIG. 5 is a block diagram of a system, according to some embodiments.

### DETAILED DESCRIPTION

Techniques are described relating to diversity ranking techniques that be used to select groups of items having diverse characteristics. Such techniques may be useful when selecting a limited number of items from a larger number of possible candidate items (e.g. a user might be sent a communication with only five items in it, but there may be dozens, hundreds, or even thousands of items to choose from in filling those five slots).

These diversity ranking techniques can be used on many different kinds of items, but in some cases, are used on consumer merchandise items (e.g. clothing, apparel, and other goods) that a user may wish to purchase. The techniques are broadly applicable, however, and are not limited to these items and contexts. Another possible context for use is digital advertising (e.g. choosing which set of ads to present to a user among hundreds, thousands, or even more possible ads). Diversity is desirable in various circumstances, as a communication may be less effective when it includes items that are too similar to one another.

Techniques in this disclosure include assessing diversity of items in a set, where each of those items has one or more associated attribute values (also referred to as tags). These attribute values can vary by item, but can include various data or metadata about a good, service, and/or piece of information (i.e., items being ranked for diversity purposes can be anything as long as those items have some associated descriptive values that can be used to assess diversity, in various embodiments).

In some cases, items may also have an associated score. This score can be customized based on knowledge about a user. Thus, a same item may have a higher item score for one user (or group of users) and a lower item score for another user (or group of users). These item scores (e.g. relevance scores) can be combined with diversity scores to produce a weighted diversity ranking score. This weighted score can then be used to determine whether a particular candidate item should be added to a set of existing items (e.g. a set of items already selected).

A window size can also be used when performing diversity ranking. In some cases, a candidate item may be included in a subset of an existing set of items, where the diversity ranking function only operates on an evaluation set that includes only the subset of items plus the candidate item. It may be the case, for example, that a user who receives a final list of items does not care as much whether an initial item in the list is similar to 12th item to be included in the list—these items may be presented to the user in spatially different locations, for example. Thus, only a subset of an existing set of items may be examined when calculating diversity scores to determine which particular candidate item should be included in the existing set.

This specification includes references to “one embodiment,” “some embodiments,” or “an embodiment.” The appearances of these phrases do not necessarily refer to the same embodiment. Particular features, structures, or characteristics may be combined in any suitable manner consistent with this disclosure.

“First,” “Second,” etc. As used herein, these terms are used as labels for nouns that they precede, and do not necessarily imply any type of ordering (e.g., spatial, temporal, logical, cardinal, etc.).

Various components may be described or claimed as “configured to” perform a task or tasks. In such contexts, “configured to” is used to connote structure by indicating that the components include structure (e.g., stored logic) that performs the task or tasks during operation. As such, the component can be said to be configured to perform the task even when the component is not currently operational (e.g., is not on). Reciting that a component is “configured to” perform one or more tasks is expressly intended not to invoke 35 U.S.C. § 112(f) for that component.

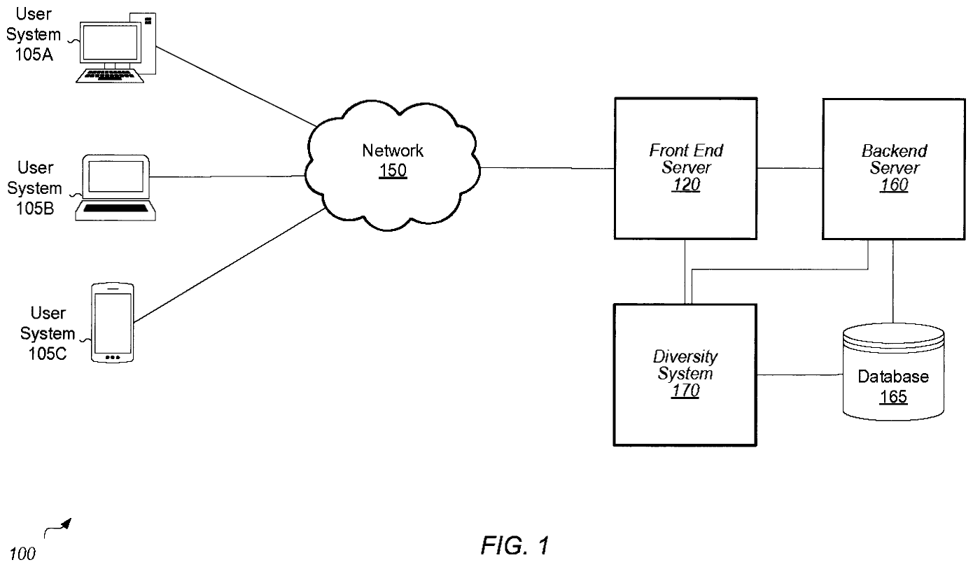

Turning to FIG. 1, a block diagram of a system 100 is shown, according to various embodiments. In this diagram, system 100 includes user systems 105A, 105B, and 105C. System 100 also includes front end server 120, backend server 160, database 165, diversity system 170, and network 150. The techniques described herein can be utilized in the environment of system 100, as well as numerous other types of environment.

Note that many other permutations of FIG. 1 are contemplated (as with all figures). While certain connections are shown (e.g. data link connections) between different components, in various embodiments, additional connections and/or components may exist that are not depicted. As will be appreciated by one of skill in the art, various devices may be omitted from this diagram for simplicity—thus, in various embodiments, routers, switches, load balancers, computing clusters, additional databases, servers, and firewalls, etc., may all be present and utilized. Components may be combined with one other and/or separated into one or more systems in this figure, as in other figures.

User systems 105A, 105B, and 105C (“user systems 105”) may be any user computer system that can potentially interact with front end server 120, according to various embodiments. Front end server 120 may send communications to users, such as emails, text messages, etc. These communications may contain items selected using diversity ranking techniques described below. (Another system beside front end server 120 may send the messages, in some embodiments.)

Front end server 120 may also provide web pages that facilitate one or more services, such as account access and electronic payment transactions (as may be provided by PayPal.com™). Front end server 120 may thus facilitate access to various electronic resources, which can include an account, data, and various software programs/functionality, etc.

A user of user system 105A may receive communications from front end server 120. A user may receive an email, text message, or other communication containing different offers to purchase different items, for example. The communication may thus contain a particular number of “deals” offered to a user (where each deal is an offer to buy one or more items).

These items in the communication can be various goods and/or services, but can include clothing and personal apparel items in some cases. Thus, a user might receive an email that includes offers to buy a pair of black leather men's boots, a red hat, a tie-dyed t-shirt, a digital wristwatch with a brown cloth strap, and other items. The communication may include pictures and/or descriptions of the items, and can include associated hyperlinks (or another mechanism) usable to initiate an action related to the items. The user can initiate a purchase for one or more of the items, for example, request a notification when the item comes on sale, add the item to a digital shopping cart, add the item to a wish list, and/or take a different action.

In some embodiments, communications with items in them can be provided to a user via a web page. A merchant, for example, may customize a web page for a particular user with items selected for that user. Front end server 120 may thus provide a listing of items (that may have been selected using a diversity ranking technique) to another computer system, which then uses that listing to present the items to the user via web page. As an example, consider a user who visits Merchant XYZ's web store. Merchant XYZ's web server may contact front end server 120 (or some other system), and receive in return a list of items (selected by diversity ranking) to be presented to that particular user. The selection of the items can be based on personal information regarding the user.

Front end server 120 may be any computer system configured to provide access to electronic resources. This can include providing communications to users and/or web content, in various embodiments, as well as access to functionality provided a web client (or via other protocols, including but not limited to SSH, FTP, database and/or API connections, etc.). Services provided may include serving web pages (e.g. in response to a HTTP request) and/or providing an interface to functionality provided by backend server 160 and/or database 165. Database 165 may include various data, such as user account data, system data, and any other information. Multiple such databases may exist, of course, in various embodiments, and can be spread across one or more data centers, cloud computing services, etc. Front end server 120 may comprise one or more computing devices each having a processor and a memory. Network 150 may comprise all or a portion of the Internet.

Front end server 120 may correspond to an electronic payment transaction service such as that provided by PayPal™ in some embodiments, though in other embodiments, front end server 120 may correspond to different services and functionality. Front end server 120 and/or backend server 160 may have a variety of associated user accounts allowing users to make payments electronically and to receive payments electronically. A user account may have a variety of associated funding mechanisms (e.g. a linked bank account, a credit card, etc.) and may also maintain a currency balance in the electronic payment account. A number of possible different funding sources can be used to provide a source of funds (credit, checking, balance, etc.). User devices (smart phones, laptops, desktops, embedded systems, wearable devices, etc.) can be used to access electronic payment accounts such as those provided by PayPal™. In various embodiments, quantities other than currency may be exchanged via front end server 120 and/or backend server 160, including but not limited to stocks, commodities, gift cards, incentive points (e.g. from airlines or hotels), etc. Server system 120 may also correspond to a system providing functionalities such as API access, a file server, or another type of service with user accounts in some embodiments (and such services can also be provided via front end server 120 in various embodiments).

Database 165 can include a transaction database having records related to various transactions taken by users of a transaction system in the embodiment shown. These records can include any number of details, such as any information related to a transaction or to an action taken by a user on a web page or an application installed on a computing device (e.g., the PayPal app on a smartphone). Many or all of the records in database 165 are transaction records including details of a user sending or receiving currency (or some other quantity, such as credit card award points, cryptocurrency, etc.). The database information may include two or more parties involved in an electronic payment transaction, date and time of transaction, amount of currency, whether the transaction is a recurring transaction, source of funds/type of funding instrument, and any other details. Such information may be used for bookkeeping purposes as well as for risk assessment (e.g. fraud and risk determinations can be made using historical data; such determinations may be made using systems and risk models not depicted in FIG. 1 for purposes of simplicity). As will be appreciated, there may be more than simply one database in system 100. Additional databases can include many types of different data beyond transactional data. Any description herein relative to database 165 may thus be applied to other (non-pictured) databases as well.

Backend server 160 may be one or more computing devices each having a memory and processor that enable a variety of services. Backend server 160 may be deployed in various configurations. In some instances, all or a portion of the functionality for web services that is enabled by backend server 160 is accessible only via front end server 120 (e.g. some of the functionality provided by backend server 160 may not be publicly accessible via the Internet unless a user goes through front end server 120 or some other type of gateway system).

Diversity system 170 likewise may be one or more computing devices each having a memory and processor. In various embodiments, diversity system 170 performs operations related to diversity ranking of items. Diversity system 170 may thus transmit information to and/or receive information from a number of systems, including database 165, front end server 120, and back end server 160, as well as other systems, in various embodiments. (Note that diversity system 170 may of course also be a server system and no special meaning should be given to the names used to describe the components of FIG. 1).

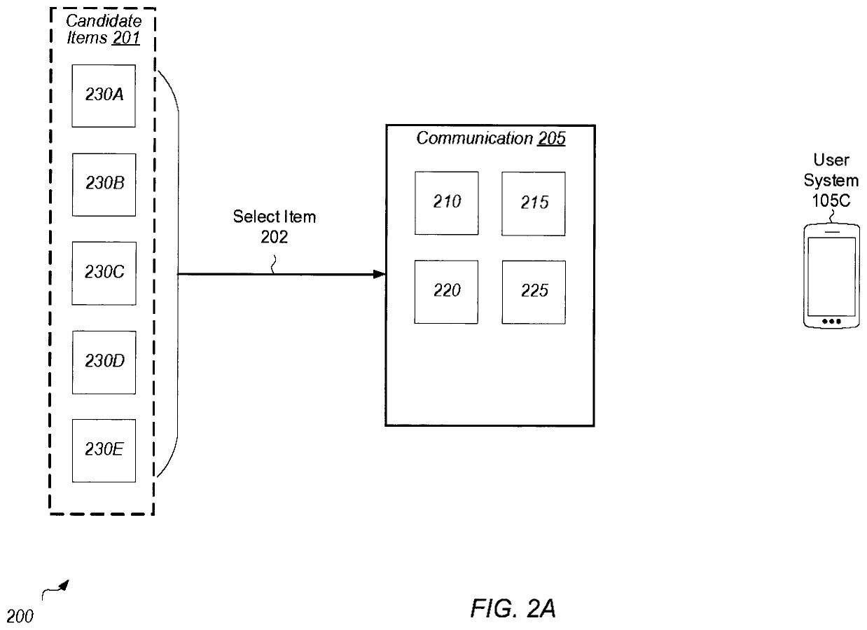

Turning to FIG. 2A, a diagram is shown of a system 200 relating to the selection of items for transmission to a user system. Concepts introduced relative to this diagram will be explained in further detail relative to other diagrams further below.

In FIG. 2A, communication 205 already includes items 210, 215, 220, and 225 (i.e. these items have already been selected to send to user system 105C). In operation 202, diversity system 170 selects an item from a list of candidate items 201. The candidate items include items 230A, 230B, 230C, 230D, and 230E (“candidate items 230”). Each of these items, as well as the items already in communication 205, may have various associated data about them. This data may include information such as price of item, type of item (e.g. shirt, shoes, etc.), brand (e.g. Calvin Klein™, Ralph Lauren™, etc′.) color, description and/or title, size, style (e.g. mens, womens, kids), in the case of clothing related items. More broadly, any data can be associated with any item—this may vary widely depending on type of item. Electronics, books, automobiles, labor services, etc. may all have different associated characteristic data, for example.

Operation 202 may select one of candidate items 230 using a diversity ranking technique that results in communication 205 having an optimally diverse group of items (or an approximation thereof). If items 205 and 220 are both shoes, for example, and candidate item 230B is also a pair of shoes, then it may not make sense to send to user system 105C a list of items where three of the five items are shoes.

Turning to FIG. 2B, a further diagram is shown of a system 250 relating to the selection of items for transmission to user system 105C. In this diagram, candidate item 230D has been selected for transmission, which occurs in operation 204. Candidate item 230D is also removed from the list of candidate items 201, and has been replaced with new candidate item 230F. Accordingly, if another new candidate item is chosen to be included in communication 205, it may be chosen from the list [230A, 230B, 230C, 230E, 230F].

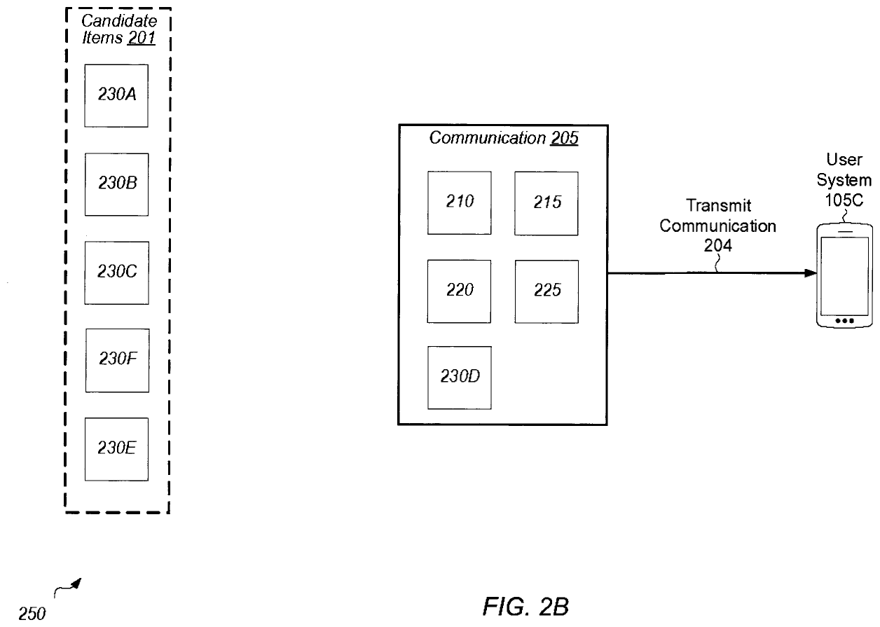

Turning to FIG. 3, a flowchart is shown of one embodiment of a method 300 relating to diversity ranking of items, according to various embodiments.

Operations described relative to FIG. 3 may be performed, in various embodiments, by any suitable computer system and/or combination of computer systems, including diversity system 170. For convenience and ease of explanation, operations described below will simply be discussed relative to diversity system 170 rather than any other system, however. Further, various operations and elements of operations discussed below may be modified, omitted, and/or used in a different manner or different order than that indicated. Thus, in some embodiments, diversity system 170 may perform one or more operations while another system might perform one or more other operations.

In operation 310, diversity system 170 accesses a candidate list of items, each of which may be included in an existing set of items, where the candidate list of items and the existing set of items each have one or more respectively associated attribute values, according to various embodiments. The existing set of items can be a list of items that are going to be communicated to a user (e.g. in an email, via a web page, etc.). In other words, these items have already been selected (e.g. using a diversity ranking process), but have not yet been sent to the user, in various embodiments.

The candidate list of items is a list of two or more items that can be selected for inclusion in an existing set of items, in various embodiments. The items can be anything—goods (e.g. clothing, shoes, watches, cars, electronics, etc.) or services. Note that “including an item in an existing set of items” refers to manipulating a digital data structure that contains information regarding the existing set, in various embodiments, and not e.g. physically adding a shirt to a collection of other physical clothing items. Thus, this term can be understood to mean “including (information about) an item in an existing set of (collected information about other) items” according to various embodiments. Also note that the “existing set of items” can be the empty set in some circumstances (e.g. no item has yet been added to the set of already-included items). The algorithms disclosed are still suitable even when the existing set is empty, in various embodiments (though the existing set may include one or more items in it, of course).

The candidate list of items can be stored in any suitable data structure. An array, linked list, relational database, or another type of data structure may be used, for example. The candidate list of items can be stored on diversity system 170 or another location accessible to that system.

Each of the candidate list of items and the existing set of items can have one or more respectively associated attribute values (aka tags). These attribute values can be used to measure diversity. More particularly, the attribute values for an item may describe any property of the item or anything related to the item, in various embodiments. Attribute values can vary widely, but may include color, size, price, brand, country of manufacture, target consumer group (e.g. women's, men's, children's), etc. An item may be said to be “tagged” with particular attribute values. Thus, an article of clothing item might be “tagged” with the attribute values “red”, “sweater”, “women's”, “Burberry™” [a brand name], “$480.” Items can have one or more tags in various embodiments. Comparing attribute values can ensure good diversity of items in a set, as discussed further below.

### Item Scores, Item Clustering & Selecting Candidate Items

Items can have scores in addition to attribute values. These scores may represent a perceived desirability and/or relevance of the item, and in some instances can be particular to a user profile (or a profile for a group of users, e.g., United States male age 35-39).

An item could receive a higher score for a particular user based on knowledge of that user. If a user has previously put a red sweater in a digital shopping cart (but perhaps failed to complete the purchase), for example, it can be inferred that user may have a special interest in buying a sweater and may like the color red. Clothing items that are sweaters and/or colored red may thus be rated higher for that particular user. Thus, in some cases, the same item will have different relevance scores for different users.

The list of candidate items can be created in some instances by taking a first top-scoring item from a first group of items, a second top-scoring item from a second group of items, etc. In the case of apparel, a first group of items could be shoes, a second group of items could be socks, and a third group of items could be jeans, for example. Each of the items in these groups may have an associated score, and a candidate list could then be assembled be taking one top scoring item from each respective group. Other methodologies can be used to create a candidate list of items.

When an item from a candidate list is added to an existing set, the item is removed from the candidate list in various embodiments. That item can then be replaced in the candidate list using a similar process—e.g., if an item from a particular category (shoes) is added to the existing set, then the next top-scoring item from the shoes category can be promoted to the candidate list. Other methodologies can also be used to replace an item removed from the candidate list and placed in the existing set as well.

Item score may be considered in the diversity ranking process, as will be explained further below. An item with an extremely high relevance score, for example, might be added to an existing set of items (to be communicated to a user) even if it makes the resulting set of items slightly less diverse than another item (when not taking score into account).

Clustering techniques are used to generate a candidate list of items in some embodiments, by taking a highest scoring item from a plurality of item clusters, for example. Items can be placed into different clusters based on a common shared attribute value—for example, all items that have the attribute value “shoe” might be clustered together in a first cluster, items that have the attribute value “pants” could be clustered in a second cluster, etc. In some cases, clusters may be segregated so that there is no overlap (e.g. each unique item only appears in one of a particular group of clusters) while in other embodiments, an item might appear in two or more clusters (e.g., a brown leather shoe might be placed in one cluster for “shoe” and also placed in a second cluster for “leather”). These clusters can be pre-ranked based on item score.

Cluster pre-ranking can be particularly helpful in cases of selecting diverse items when building up a set of items (e.g. which may be communicated to an end user). Consider a scenario where there are 5,000 different candidate items that might be chosen to add to an existing set of items. It would be computationally exhausting to try to assess diversity for 5,000 different items before picking one and adding it to the existing set. Then, another 4,999 items might again have to be assessed for diversity before adding the next candidate item to the existing set.

When items are clustered and pre-ranked, however, then only a top scoring item (or an item that meets some other scoring criterion) needs to be assessed for diversity. Now again consider the 5,000 item scenario, except this time those items are pre-ranked and clustered into 30 different clusters. Instead of having to assess 5,000 candidate items for possible inclusion into an existing set of items, a mere 30 items (e.g. the top scoring items from each clusters) can be considered. This makes the diversity assessment much more computationally feasible, particularly when the diversity scoring is being used as a part of a communication campaign (e.g. building a daily list of emails to send to a variety of end users).

In operation 320, diversity system 170 calculates, for each of a candidate list of items, a respective diversity ranking score for that candidate item based on that candidate item being included in the existing set of items, according to various embodiments. In one embodiment, the diversity ranking score can be calculated using the following algorithm:

These diversity ranking scores may thus represent (1) the total diversity of the existing set plus the first candidate item, (2) the total diversity of the existing set plus the second candidate item, etc. The highest diversity ranking score can then be used to decide that a particular corresponding item should be added to the existing set of items (and removed from the candidate list of items) in various embodiments. In other words, the diversity ranking score for a particular candidate item may represent a desirability of including that candidate item in an existing item set.

Generally speaking, the more often a given attribute value (i.e. tag) appears in a set of items, the less diverse that set is, in various embodiments. Consider a set of items having the attribute values indicated below:

Item 1: [sweater, red, wool];

Item 2: [sweater, red, cotton];

Item 3: [sweater, blue, wool].

Such a set is less diverse than this set:

Item 4: [jeans, black, denim]

Item 5: [sweater, purple, wool];

Item 6: [shoes, green, leather].

In the first set, the total set of attribute values includes “sweater” (three appearances), “red” (two appearances), “wool” (two appearances), “cotton” (one appearance), and “blue” (one appearance). In the second set of items, however, there are nine distinct attribute values, each of which appears only a single time amongst all the items in the set.

In some embodiments, a diversity ranking score can be calculated based on the following algorithm:

$$diversity ( S ) = \frac{{\sum }_{t ∈ T} ( \frac{1 - {e}^{- α c} t}{1 - {e}^{- α}} ) \times i d {f}^{2} ( t )}{{\sum }_{t ∈ T} {c}_{t} \times i d {f}^{2} ( t )}$$

This algorithm provides a diversity ranking score for a particular set of items (e.g. the existing set of items with one of the candidate items included as well). The following pages include two detailed examples of evaluating this formula, relative to two different sets of items. Broadly speaking, the numerator portion of the algorithm above represents a diversity score for a given set of items having particular attribute values, while the denominator portion is used to normalize values when the resulting sets have differing quantities of attribute values, according to various embodiments.

The first portion of this formula, in the numerator, is:

$${\sum }_{t ∈ T} \frac{1 - {e}^{- α Ct}}{1 - {e}^{- α}} \times id {f}^{2} ( t )$$

(or IDF(t)) and this portion may be referred to as a “first diversity subscore” in some embodiments. In this subscore, the parameter alpha (α) is an adjustable value that can be used to increase or decrease a penalty for different attribute values appearing multiple times in the same set (e.g., the diversity ranking score for that set will be lower as the value for alpha is increased). Alpha may be 0.5 in some embodiments, but can be any number as desired. Ct is the total number of appearances of a particular tag t.

This first diversity subscore can be calculated as follows. The set of all attribute values (i.e. tags) for a set of items is determined—e.g. what is the set of all tags that appear at least once in the set (existing set of items+candidate item)? This set of all tags is denoted as Tin the formula portion above. An iteration is then performed—a value is calculated for each unique tag tin the total set of tags T. These values for each tag in the set of all tags are then added together to get the total first diversity subscore.

Consider the following example, where two different sets will have their first diversity subscores measured. Set #1 is two existing items plus another candidate item, and consists of:

SET #1 Item 1: [red, sweater, wool]
Item 2: [blue, sweater, wool]
Item 3: [red, shirt, wool] (candidate item)

There are five unique tags, so the set T=[red, blue, sweater, shirt, wool]. These tags appear the following corresponding number of times in the set that is being diversity ranked: [2 (red), 1 (blue), 2 (sweater), 1 (shirt), 3 (wool). The first diversity subscore, using an alpha value of 0.5, can then be expressed based on the following:

$${\frac{1 - {e}^{- ( 0.5 ) ( 2 )}}{1 - {e}^{- ( 0.5 )}}}_{( Red )} + {\frac{1 - {e}^{- ( 0.5 ) ( 1 )}}{1 - {e}^{- ( 0.5 )}}}_{( Blue )} + {\frac{1 - {e}^{- ( 0.5 ) ( 2 )}}{1 - {e}^{- ( 0.5 )}}}_{( Sweater )} + {\frac{1 - {e}^{- ( 0.5 ) ( 1 )}}{1 - {e}^{- ( 0.5 )}}}_{( Shirt )} + {\frac{1 - {e}^{- ( 0.5 ) ( 3 )}}{1 - {e}^{- ( 0.5 )}}}_{( Wool )}$$

In the above, using an approximation for Euler's number e, these terms evaluate as follows:

1.61+1+1.61+1+1.97=7.19

Now consider a second set with the same first two items, but a different third candidate item:

SET #2 Item 1: [red, sweater, wool]
Item 2: [blue, sweater, wool]
Item 4: [red, shirt, cotton] (candidate item)
   There are now six unique tags, so the set T=[red, blue, sweater, shirt, wool, cotton]. The formula for the first diversity subscore is now based on:

$${\frac{1 - {e}^{- ( 0.5 ) ( 2 )}}{1 - {e}^{- ( 0.5 )}}}_{( Red )} + {\frac{1 - {e}^{- ( 0.5 ) ( 1 )}}{1 - {e}^{- ( 0.5 )}}}_{( Blue )} + {\frac{1 - {e}^{- ( 0.5 ) ( 2 )}}{1 - {e}^{- ( 0.5 )}}}_{( Sweater )} + {\frac{1 - {e}^{- ( 0.5 ) ( 1 )}}{1 - {e}^{- ( 0.5 )}}}_{( Shirt )} + {\frac{1 - {e}^{- ( 0.5 ) ( 2 )}}{1 - {e}^{- ( 0.5 )}}}_{( Wool )} + {\frac{1 - {e}^{- ( 0.5 ) ( 1 )}}{1 - {e}^{- ( 0.5 )}}}_{( Cotton )}$$

Again, using an approximation for Euler's number e, this evaluates as follows:

1.61+1+1.61+1+1.61+1=7.83

These first values for Set #1 and Set #2 are not the end of calculations, however, according to various embodiments. The first diversity subscore can further be calculated based on the inverse document frequency idf²(t), or IDF(t).

The inverse document frequency is an algorithm that will return a higher value for more rare tags, and a lower value for more common tags, according to various embodiments. Inverse document frequency can thus increase diversity ranking scores when more unique or uncommon tags are present in a set of tags (and likewise, sets with frequently occurring tags will score lower).

Thus, the IDF for “blue” (a unique tag in Sets #1 and #2 above) will be a higher value than the IDF for “wool” (which appears three times in Set #1 and twice in Set #2). As just one example, IDF(t) can be defined as

IDF(t)=ln((total number of items set 7)/(number of items in which tag t appears))

where ln is the natural log function (log base e). Note that different types of inverse document frequency functions may be used in different embodiments, however, and the above is just one example. For set #1, the resulting IDF values are shown below:

| ln(5/2) | ln(5/1) | ln(5/2) | ln(5/1) | ln(5/3) |
|---|---|---|---|---|
| 0.92 | 1.61 | 0.92 | 1.61 | 0.51 |
| Red | Blue | Sweater | Shirt | Wool |

Referring back again to an example diversity ranking score formula, which is:

$$diversity ( S ) = \frac{{\sum }_{t ∈ T} ( \frac{1 - {e}^{- α c} t}{1 - {e}^{- α}} ) \times i d {f}^{2} ( t )}{{\sum }_{t ∈ T} {c}_{t} \times i d {f}^{2} ( t )}$$

the numerator portion for Set #1 can then be calculated as follows:

1.61*0.92+1*1.61+1.61*0.92+1*1.61+1.97*0.51 or
1.48+1.61+1.48+1.61+1.00=7.18

### Red Blue Sweater Shirt Wool

As can be seen in this example above, including the inverse document frequency function results in the unique tags “blue”, and “shirt” getting higher component scores than the tags “sweater” and “red”, which appear twice. The tag “wool,” which appears the most within Set #1, has the lowest component score. In other words, for this example, the tags “blue” and “shirt” contribute the most to the diversity of Set #1, while the most commonly occurring tag “wool” contributes least to the diversity of that set.

Now, calculations will be shown for Set #2 using the inverse document frequency function (for the numerator portion of the diversity ranking score function shown above):

1.61*ln(6/2)+1*ln(6/1)+1.61*ln(6/2)+1*ln(6/1)+1.61*ln(6/2)+1*ln(6/1) or
1.77+1.79+1.77+1.79+1.77+1.79=10.68

### (Red) (Blue) (Sweater) (Shirt) (Wool) (Cotton)

Thus, in this example relating to the numerator portion of the diversity ranking score,

Set #1 first diversity subscore=7.18 and
Set #2 first diversity subscore=10.68

But yet further calculations can be used for determining the denominator—which is referred to as a second diversity subscore, in various embodiments.

The denominator in the example diversity ranking score function can help normalize the overall diversity ranking score for different sets. Notice in the numerator portion, Set #2 has more tags than Set #1 (six tags vs. five tags). Sets with greater numbers of tags may tend to receive higher numerator scores because the total size of the set T is larger (there are more tags for the number of items), according to various embodiments. Thus, the denominator can help normalize and account for this.

The denominator can be expressed as Σ_{t∈T} Ct*IDF(t). For each tag in the set T (all tags appearing at least once in the set of items), multiply the total appearance count of that tag by the inverse document frequency function for that tag, then sum those terms together. Again, continuing our examples, refer again to Set #1:

SET #1 Item 1: [red, sweater, wool]
Item 2: [blue, sweater, wool]
Item 3: [red, shirt, wool] (candidate item)
   For this set of items, the set T of all tags is [red, blue, sweater, shirt, wool]. The denominator—the second diversity ranking subscore—can thus be evaluated as follows:
   2*ln(5/2)+1*ln(5/1)+2*ln(5/2)+1*ln(5/1)+3*ln(5/3)=8.42

### Red Blue Sweater Shirt Wool

Now, calculations are shown for the denominator on Set #2, which is again repeated below for reference.

SET #2 Item 1: [red, sweater, wool]
Item 2: [blue, sweater, wool]
Item 4: [red, shirt, cotton] (candidate item)
   The set of all tags T is [red, blue, sweater, shirt, wool, cotton], a total of six.
   Second diversity ranking subscore (denominator) for Set #2 can be expressed as:

2*ln(6/2)+1*ln(6/1)+2*ln(6/2)+1*ln(6/1)+2*ln(6/2)+1*ln(6)=11.97

Now with the numerators (e.g. first diversity ranking subscore) and denominators (e.g. second diversity ranking subscore), an overall diversity ranking score can be calculated for Set #1 and Set #2—e.g. how diverse are these sets when different candidate items are included?

Set #1 diversity ranking score=7.18/8.42=0.85

Set #2 diversity ranking score=10.68/11.97=0.89

These calculations show what can intuitively be understood to be true—when the existing set of items is Item 1 and Item 2, then including candidate Item 4 (a red, cotton shirt) instead of candidate Item 3 (a red, wool shirt) produces a greater overall set diversity. This is because the pre-existing item set already has two clothing articles made from wool (red wool sweater and blue wool sweater), but it does not have any articles of clothing made from cotton. Including the first cotton item produces more diversity than including a third wool item.

In accordance with the above, calculating the diversity ranking scores can include, for each of the candidate list of items, calculating a first diversity subscore based on a set of attribute values, where each of the set of attribute values is associated with that candidate item or at least one of the existing set of items. That is, the algorithm component

$${\sum }_{t ∈ T} \frac{1 - {e}^{- α C t}}{1 - {e}^{- α}}$$

can be used to calculate the first diversity subscore. However, other algorithm components can also be used as well. The first diversity subscore can also be calculated using the IDF function, as outlined above.

The first diversity subscore for a given candidate item may decrease successively when a given attribute in the set of attributes for all items in the evaluation set is associated with an increasing quantity of items in the evaluation set (e.g., the existing set of items with the given candidate item included as well). In other words, when the candidate item has a more commonly occurring tag, the first diversity score decreases, according to various embodiments—i.e., if two candidate items both differ in only one attribute value, whichever of those attribute values is rarer in the evaluation set will produce the larger first diversity subscore.

The alpha parameter (a) mentioned above represents an attenuation parameter, in various embodiments, adjustable to increase or decrease a penalty to the first diversity subscore when a given attribute in the set of attributes is associated with two or more of items in an evaluation set consisting of the existing set of items and the given candidate item. Alpha may be 0.5 in some embodiments but a number of different values may be used. A higher alpha value in various embodiments will result in more attenuation (dropoff) in first diversity subscore.

A window size can also be used when calculating a diversity ranking score and weighted diversity ranking score (using item score). For example, a window size of five might be used, where only the most recently added five items in the existing set of items are scored for diversity ranking purposes. This window size can be adjusted for different scenarios.

Thus, calculating the respective diversity ranking score for each of a candidate list of items can be based on a diversity function assessed with a proper subset of the existing set of items. Consider an existing set of seven items in a particular ordering (with Item 1 being the initial position on the list, Item 2 being the next subsequent position on the list, etc.)

| Position in List of Existing Items: | Item Identifier |
|---|---|
| #1 | A |
| #2 | C |
| #3 | F |
| #4 | G |
| #5 | H |
| #6 | B |
| #7 | X |

If a window size of five is used, then only the last five items on the list are assessed for diversity purposes, in this example. That is, the diversity ranking function is only assessed using items F, G, H, B, X, and a candidate item. Items A and C are outside of the window size, and are ignored for diversity ranking purposes. Thus, the respective diversity ranking scores for a list of candidate items may only include diversity measurements relative to a subset of the existing item set, where the subset excludes items A and C. If the existing set of items is smaller than the window size, however, then the entire set of items is used for calculating diversity ranking scores, according to various embodiments.

In operation 330, diversity system 170, calculates, for each of a candidate list of items, a respective weighted diversity score for that candidate item based on an item score for that candidate item and based on the respective diversity ranking score for that candidate item, according to various embodiments.

Items may have a score associated with them, as noted above. This score can be based on a variety of factors, including knowledge of a user (e.g. whether a user prefers pants to skirts, natural fibers to synthetic fibers, luxury brands to generic brands, whether a user has purchased or added similar items to a digital shopping cart in the past, etc.).

When determining what item to add to an existing set of items, the item score may be taken into account. Imagine that there are two candidate items, for example, and the first one has a slightly higher diversity ranking score when included in the set of existing items. However, the item score for item #2 may be considerably higher than the item score for item #1. In this scenario, even though the diversity ranking score for item #1 is slightly better than item #2, it may be more important to include item #2 in the existing set of items because that particular item is highly relevant to a particular user (or group of users).

The weighted diversity score for a candidate item can be calculated, in one embodiment, as:

Diversity(S)×ItemScore^{β}

where S is the set of existing items as well as the candidate item, and ItemScore is the item score for that particular candidate item. The beta parameter (β) can be used to adjust the relative importance of the candidate item score in relation to the diversity score. Larger betas will result in item score receiving greater weight, while lower betas will result in item score receiving lesser weight. In some embodiments, beta may be set to 1.0, but any value can be used as desired.

Each candidate item for inclusion in an existing set of items can thus have a weighted diversity score calculated that takes into account the different item scores for those candidate items.

In operation 340, diversity system 170 determines a largest score of the weighted diversity scores of each of the list of candidate items, according to various embodiments. This is a straightforward operation, in various embodiments, that simply involves comparing the weighted diversity scores and selecting the largest one. In other words, which candidate item produces the highest score when considering both overall set diversity and also item score? This candidate item can then be chosen for inclusion in the existing set.

Thus, in operation 350, based on a particular candidate item of the list of candidate items having the largest weighted diversity score, diversity system 170 edits a data structure corresponding to the existing set of items to add that particular candidate item to the existing set of items, according to various embodiments. As noted above, the existing set of items can be stored in any number of different types of data structures. Thus, this operation may include editing an array, linked list, relational database, or another type of data structure to add the particular candidate item to the existing set of items. A particular candidate item can also be selected for inclusion but not actually added to the list—for example, this selection could include recording information indicative of which candidate item should be included. Such information could be used at a later time to add the candidate item to the list, and/or could be transmitted to another computer system for that system to include the candidate item.

In some embodiments, an existing set of items can be included in a communication to a user. The set can be included in an email, for example, or included in a web page that is viewed by the user. Diversity system 170 can cause the communication to be sent directly (e.g. initiating an email, text message, etc. to the user), or can cause the communication to be sent indirectly (e.g. sending a list of items to another system, which then transmits the items to the user, via a web page, email, or other mechanism). Note that the diversity ranking techniques described herein may apply to various types of items—in some cases, they may be also used for purposes of selecting advertisements to be shown to a user on a web page. Ads for different products or services, for example, could go through a diversity ranking process, which may also include an item score (e.g. relevance score) for each of the underlying products or services.

### Computer-Readable Medium

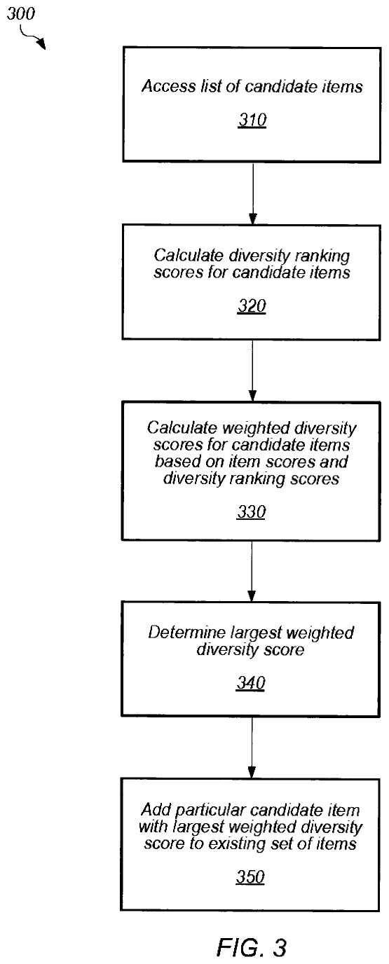

Turning to FIG. 4 a block diagram of one embodiment of a computer-readable medium 400 is shown. This computer-readable medium may store instructions corresponding to the operations of FIG. 3 and/or any techniques described herein. Thus, in one embodiment, instructions corresponding to diversity system 170 may be stored on computer-readable medium 400.

Note that more generally, program instructions may be stored on a non-volatile medium such as a hard disk or FLASH drive, or may be stored in any other volatile or non-volatile memory medium or device as is well known, such as a ROM or RAM, or provided on any media capable of staring program code, such as a compact disk (CD) medium, DVD medium, holographic storage, networked storage, etc. Additionally, program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a server or server system such as, for example, in C, C+, HTML, Java, JavaScript, or any other scripting language, such as Perl. Note that as used herein, the term “computer-readable medium” refers to a non-transitory computer readable medium.

### Computer System

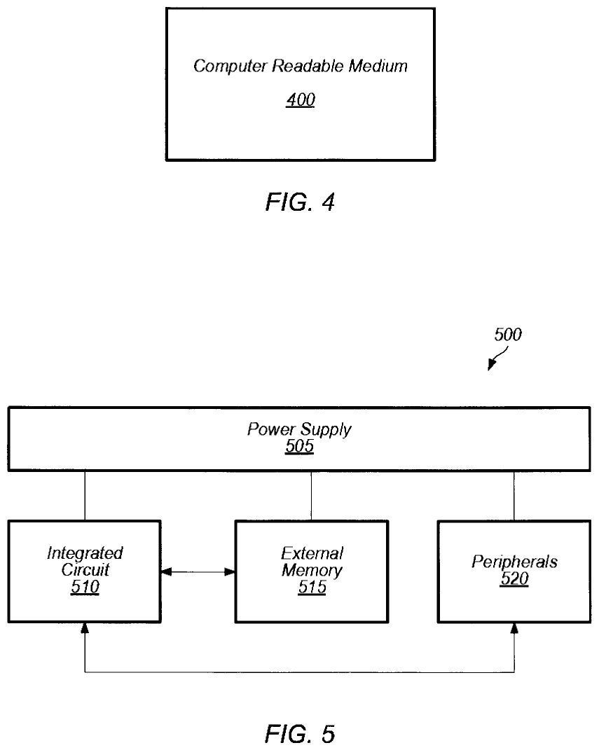

In FIG. 5, one embodiment of a computer system 500 is illustrated. Various embodiments of this system may be included in front end server 120, backend server 160, diversity system 170, or any other computer system.

In the illustrated embodiment, system 500 includes at least one instance of an integrated circuit (processor) 510 coupled to an external memory 515. The external memory 515 may form a main memory subsystem in one embodiment. The integrated circuit 510 is coupled to one or more peripherals 520 and the external memory 515. A power supply 505 is also provided which supplies one or more supply voltages to the integrated circuit 510 as well as one or more supply voltages to the memory 515 and/or the peripherals 520. In some embodiments, more than one instance of the integrated circuit 510 may be included (and more than one external memory 515 may be included as well).

The memory 515 may be any type of memory, such as dynamic random access memory (DRAM), synchronous DRAM (SDRAM), double data rate (DDR, DDR2, DDR6, etc.) SDRAM (including mobile versions of the SDRAMs such as mDDR6, etc., and/or low power versions of the SDRAMs such as LPDDR2, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit 510 in a chip-on-chip configuration, a package-on-package configuration, or a multi-chip module configuration.

The peripherals 520 may include any desired circuitry, depending on the type of system 500. For example, in one embodiment, the system 500 may be a mobile device (e.g. personal digital assistant (PDA), smart phone, etc.) and the peripherals 520 may include devices for various types of wireless communication, such as Wi-fi, Bluetooth, cellular, global positioning system, etc. Peripherals 520 may include one or more network access cards. The peripherals 520 may also include additional storage, including RAM storage, solid state storage, or disk storage. The peripherals 520 may include user interface devices such as a display screen, including touch display screens or multitouch display screens, keyboard or other input devices, microphones, speakers, etc. In other embodiments, the system 500 may be any type of computing system (e.g. desktop personal computer, server, laptop, workstation, net top etc.). Peripherals 520 may thus include any networking or communication devices. By way of further explanation, in some embodiments system 500 may include multiple computers or computing nodes that are configured to communicate together (e.g. computing cluster, server pool, cloud computing system, etc.).

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed by various described embodiments. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method relating to diversity ranking of items, comprising:
a computer system accessing a candidate list of items, each of which may be included in an existing set of items, wherein the candidate list of items and the existing set of items each have one or more respectively associated attribute values;
for each of the candidate list of items, the computer system calculating a respective diversity ranking score for that candidate item based on that candidate item being included in the existing set of items;
wherein for each of the candidate list of items, calculating the respective diversity ranking score for that candidate item comprises calculating a first diversity subscore based on a set of attribute values, where each of the set of attribute values is associated with that candidate item or at least one of the existing set of items, and wherein for a given one of the candidate items, calculating the first diversity subscore is based on the formula
$${\sum }_{t ∈ T} \frac{1 - {e}^{- α C t}}{1 - {e}^{- α}} ,$$
where:
t represents a given attribute in the set of attributes T;
Ct represents a total count of the number of appearances of that attribute in the existing set of items as well as the number of appearances of that attribute in the given candidate item; and
α represents an attenuation parameter adjustable to increase or decrease a penalty to the first diversity subscore when a given attribute in the set of attributes is associated with two or more of items in an evaluation set consisting of the existing set of items and the given candidate item;
for each of the candidate list of items, the computer system calculating a respective weighted diversity score for that candidate item based on an item score for that candidate item and based on the respective diversity ranking score for that candidate item;
determining a largest score of the weighted diversity scores of each of the list of candidate items; and
based on a particular candidate item of the list of candidate items having the largest weighted diversity score, the computer system editing a data structure corresponding to the existing set of items to add that particular candidate item to the existing set of items.

2. The method of claim 1, wherein the first diversity subscore for a given candidate item decreases successively when a given attribute in the set of attributes is associated with an increasing quantity of the existing set of items and the given candidate item.

3. The method of claim 1, further comprising generating the candidate list of items by taking a highest scoring item from a plurality of item clusters.

4. The method of claim 3, wherein each item in a given item cluster in the plurality of item clusters shares at least one common attribute value with every other item in the given item cluster.

5. The method of claim 1, further comprising:
including the existing set of items, including the particular candidate item, in a communication to a user.

6. The method of claim 1, wherein the item scores for each of the candidate list of items are based on knowledge of a particular individual.

7. The method of claim 1, wherein for each of the candidate list of items, calculating
the respective weighted diversity score for that candidate item comprises:
multiplying the item score for that candidate item, raised to an exponential power β, by the respective diversity ranking score for that candidate item.

8. The method of claim 1, wherein the existing set of items is the empty set.

9. The method of claim 1, wherein calculating the respective diversity ranking score for each of the candidate list of items is based on a diversity function assessed with a proper subset of the existing set of items.

10. The method of claim 1, wherein calculating the respective diversity ranking score for each of the candidate list of items is based on a diversity function assessed with a every one of the existing set of items.

11. A non-transitory computer-readable medium having stored thereon instructions that when executed by a computer system cause the computer system to perform operations comprising:
accessing a candidate list of items generated by taking a highest scoring item from a plurality of item clusters,
wherein each item in a given item cluster in the plurality of item clusters shares at least one common attribute value with every other item in the given item cluster,
and wherein each item in the candidate list of items may be included in an existing set of items, wherein the candidate list of items and the existing set of items each have one or more respectively associated attribute values;
for each of the candidate list of items, calculating a respective diversity ranking score for that candidate item based on that candidate item being included in the existing set of items;
for each of the candidate list of items, calculating a respective weighted diversity score for that candidate item based on an item score for that candidate item and based on the respective diversity ranking score for that candidate item;
determining a largest score of the weighted diversity scores of each of the list of candidate items; and
selecting a particular candidate item of the list of candidate items having the largest weighted diversity score for inclusion in the existing set of items.

12. The non-transitory computer-readable medium of claim 11, wherein for each of the candidate list of items, calculating the respective diversity ranking score for that candidate item comprises:
for that candidate item, calculating a first diversity subscore based on a set of attribute values, where each of the set of attribute values is associated with that candidate item or at least one of the existing set of items.

13. The non-transitory computer-readable medium of claim 12, wherein for the given candidate item, calculating the first diversity subscore is based on the formula
$${\sum }_{t ∈ T} \frac{1 - {e}^{- α C t}}{1 - {e}^{- α}} ,$$
where:
t represents a given attribute in the set of attributes T;
Ct represents a total count of the number of appearances of that attribute in the existing set of items as well as the number of appearances of that attribute in the given candidate item; and
α represents an attenuation parameter adjustable to increase or decrease a penalty to the first diversity subscore when a given attribute in the set of attributes is associated with two or more of items in an evaluation set consisting of the existing set of items and the given candidate item.

14. The non-transitory computer-readable medium of claim 11, wherein the operations further comprise:
including the particular candidate item in the existing set of items; and
causing a communication of the existing set of items, including the particular candidate item, to be sent to a user.

15. The non-transitory computer-readable medium of claim 11, wherein for each of the candidate list of items, calculating the respective weighted diversity score for that candidate item comprises multiplying the item score for that candidate item by the respective diversity ranking score for that candidate item.

16. A system, comprising:
a processor; and
a non-transitory computer-readable medium having stored thereon instructions that when executed cause the system to perform operations comprising:
accessing a candidate list of items, each of which may be included in an existing set of items, wherein the candidate list of items and the existing set of items each have one or more respectively associated attribute values;
for each of the candidate list of items, calculating a respective diversity ranking score for that candidate item based on that candidate item being included in the existing set of items;
wherein for each of the candidate list of items, calculating the respective diversity ranking score for that candidate item comprises calculating a first diversity subscore based on a set of attribute values, where each of the set of attribute values is associated with that candidate item or at least one of the existing set of items, and wherein for a given one of the candidate items, calculating the first diversity subscore is based on the formula
$${\sum }_{t ∈ T} \frac{1 - {e}^{- α C t}}{1 - {e}^{- α}} ,$$
where:
t represents a given attribute in the set of attributes T;
Ct represents a total count of the number of appearances of that attribute in the existing set of items as well as the number of appearances of that attribute in the given candidate item; and
α represents an attenuation parameter adjustable to increase or decrease a penalty to the first diversity subscore when a given attribute in the set of attributes is associated with two or more of items in an evaluation set consisting of the existing set of items and the given candidate item;
for each of the candidate list of items, calculating a respective weighted diversity score for that candidate item based on an item score for that candidate item and based on the respective diversity ranking score for that candidate item;
determining a largest score of the weighted diversity scores of each of the list of candidate items; and
based on a particular candidate item of the list of candidate items having the largest weighted diversity score, editing a data structure corresponding to the existing set of items to add that particular candidate item to the existing set of items.

17. The system of claim 16, wherein the operations further comprise generating the candidate list of items by taking a highest scoring item from a plurality of item clusters.

18. The system of claim 17, wherein each item in a given item cluster in the plurality of item clusters appears only within that given item cluster and not in any of the others of the plurality of item clusters.

19. The system of claim 17, wherein the operations further comprise assigning an item score to individual items in each of the plurality of item clusters prior to calculating a respective diversity ranking score for each of the candidate list of items.

20. The system of claim 16, wherein the operations further comprise:
transmitting at least a portion of the existing set of items and the particular candidate item to a user.
